(19) United States
(12) Patent Application Publication
(10) Pub. No.: US 2022/0047124 A1
(43) Pub. Date: Feb. 17, 2022

(54) PORTABLE FLUID DISPENSING APPARATUSES

(71) Applicant: Olika Inc., Greenbrae, CA (US)

(72) Inventors: Michael Rutchik, Belvedere, CA (US); Dean Reid, Kowloon (HK)

(73) Assignee: Olika Inc., Greenbrae, CA (US)

(21) Appl. No.: 17/400,909

(22) Filed: Aug. 12, 2021

Related U.S. Application Data
(60) Provisional application No. 63/064,519, filed on Aug. 12, 2020.

(51) Int. Cl. A47K 5/12; B05B 11/00

(52) U.S. Cl. CPC A47K 5/1201; A47K 5/1205; B05B 11/3052; B05B 11/0038; B05B 11/3001

(57) ABSTRACT

Portable fluid dispensing apparatuses are disclosed. In some embodiments, the apparatus includes an upper assembly and a lower assembly. The lower assembly includes a base shell and a lid removably coupled to the base shell. The upper assembly includes an upper shell attached to the lid and having a first aperture. The upper assembly additionally includes a fluid dispenser attached to a neck portion of the lid and received. The fluid dispenser includes an actuator nozzle, a first tube received in a first internal compartment of the base shell, a pump disposed between the nozzle and the first tube. The upper assembly further includes a pump control member having a second tube connected to the nozzle. The pump control member is sized to allow movement of the pump control member and the nozzle toward the pump to activate the pump and dispense fluid stored in the first internal compartment.

### CROSS-REFERENCE TO RELATED APPLICATIONS

This application claims the benefit of U.S. Patent Application Provisional Ser. No. 63/064,519 filed Aug. 12, 2020 and entitled “Portable Spray Bottle.” The complete disclosure of the above application is hereby incorporated by reference for all purposes.

### TECHNICAL FIELD

The present disclosure relates to portable, hand-held apparatuses for dispensing fluid, and more particularly to portable fluid dispensing apparatuses or hand sanitizer devices for dispensing fluid hand sanitizer.

### BACKGROUND

Various types of devices for storing and dispensing sanitizers are known, and they are often designed for specific types of sanitizing means. For example, pumps or spray nozzles can be attached to containers of different sizes and shapes to enable delivery of fluid sanitizers, including liquid and gel-type sanitizers. In particular, alcohol-based gels can be squirted from a manual or automatic pump dispenser into a user's hands, which evaporate when the hands are rubbed together for cleaning.

Hand sanitizers are particularly useful when soap, water, and towels are not available. This most often occurs when a user is traveling, particularly with children. However, providing sanitizers in a compact, portable package for ready use is challenging. Liquid sanitizers can evaporate or spill when carried, for example, in a pocket or purse, and wet wipes can similarly become dried out and unusable. In addition, since single purpose containers must be disposed when empty, adding waste and cost, it would be particularly desirable for a refillable dispenser.

Since the coronavirus pandemic began, people have become increasingly interested in preventing the spread of germs, there is a need for a sanitizer dispensing device that is portable and capable of storing and dispensing a wet hand sanitizing fluid for thorough hand cleansing.

### SUMMARY

The present disclosure relates to a fluid dispensing apparatus or hand sanitizer device that is portable and houses sanitizing liquid. In various embodiments, the portable fluid dispensing apparatus has an upper assembly and a lower assembly. The lower assembly comprises a base shell and a lid that collectively forms a container or interior compartment for storing sanitizing liquid. The upper assembly comprises an upper shell coupled to the lid and a means for dispensing fluid sanitizer, such as a dispenser that comprises a pump for dispensing fluid sanitizer when depressed.

Also disclosed is a method of dispensing fluid sanitizer using the disclosed portable fluid dispensing apparatus. In one embodiment, the method comprises providing a portable fluid dispensing apparatus described herein, filling the container with fluid sanitizer, removing a removable plug, and dispensing fluid sanitizer by depressing the pump control to contact the pump inserted into the fluid sanitizer. These steps may be repeated until the fluid sanitizer is consumed, and the container may be refilled with fluid sanitizer as needed, such as by uncoupling the base shell from the rest of the device.

### BRIEF DESCRIPTION OF THE DRAWINGS

The foregoing and other objects, features, aspects, and advantages of the embodiments disclosed herein will become more apparent from the following detailed description when taken in conjunction with the following accompanying drawings:

FIGS. 1-2 show isometric views of an example of a portable fluid dispensing apparatus of the present disclosure;

FIG. 3 shows a front view of the portable fluid dispensing apparatus of FIGS. 1-2;

FIG. 4 shows a partial sectional view of the portable fluid dispensing apparatus of FIGS. 1-2 taken along lines 4-4 in FIG. 3, showing a lid attached to an upper shell;

FIG. 5 shows a partial exploded view of the portable fluid dispensing apparatus of FIGS. 1-2;

FIG. 6 shows a sectional view of the portable fluid dispensing apparatus of FIGS. 1-2 taken along lines 6-6 in FIG. 3, showing a fluid dispenser in an unactuated state;

FIG. 7 shows the sectional view of FIG. 6 showing the fluid dispenser in an actuated state;

FIG. 8 shows a sectional and exploded view of an upper shell and pump control of the portable fluid dispensing apparatus of FIGS. 1-2;

FIG. 9 shows a side view of the portable fluid dispensing apparatus of FIGS. 1-2 shown with an upper shell removably coupled from a lower shell and a plug removed from a discharge opening of the upper shell;

FIGS. 10-11 show isometric views of another example of a portable fluid dispensing apparatus of the present disclosure;

FIG. 12 shows a front view of the portable fluid dispensing apparatus of FIGS. 10-11; and

FIG. 13 shows a sectional view of the portable fluid dispensing apparatus of FIGS. 10-11 taken along lines 13-13 in FIG. 12, showing a fluid dispenser in an unactuated state.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION

The present disclosure describes a fluid dispensing apparatus or sanitizer device that is portable and can store and dispense a fluid sanitizer as needed, for example, to clean a user's hands.

The fluid dispensing apparatus of the present disclosure comprises an upper assembly and a lower assembly which are combined to form the apparatus. The lower assembly comprises a base shell and a lid, and the upper assembly comprises an upper shell and a fluid dispenser. The shells, when coupled to each other, form an outer housing for the device. Each shell can have any size, shape, and texture as desired for the intended application, including aesthetics, ergonomics, and cost, and, when combined, create the overall geometry and design of the device. For example, the upper shell may have a round outer profile configured to conform comfortably with a user's hands, particularly as fluid sanitizer is dispensed. In addition, the base shell may have round or curved outer profile also to conform to a user's hand when held, and may particularly be substantially spherical in shape to store the fluid sanitizer. The base shell may also have a flat section to allow the device to stand upright. Specific examples are described in more detail below.

In some examples, the base shell and the lid form a container or an interior or internal compartment therebetween configured for storing fluid sanitizer. The walls forming the outer surfaces of the base shell and lid also may be the same walls that form the inner surfaces in which the internal compartment is formed therebetween. The fluid sanitizer includes any known aqueous or alcohol-based liquid, dispersion, or gel-type hand sanitizer. For example, the lid may include a neck portion or flange as a means for supporting a fluid sanitizer dispenser, and the base shell is coupled or otherwise attached (e.g., via a threaded connection), to the lid, thereby forming the lower compartment. In addition, the lid may further comprise at least one access or opening into the lower compartment and through which fluid sanitizer can be dispensed.

The upper assembly of the portable fluid dispensing apparatus may comprise at least one upper shell that receives the fluid dispenser. In a particular embodiment, the fluid dispenser is a dispensing pump. The pump can be any device which, when inserted into the sanitizer in the container and depressed, is capable of dispensing the fluid sanitizer, such as into a user's hand.

The portable fluid dispensing apparatus may further comprise a nozzle or discharge tube, which preferably protrudes through the side of the upper shell, particularly horizontally, enabling the pump to deliver and direct sanitizer either as a spray or as a pool or single shot, as appropriate for the type and viscosity of the fluid sanitizer. As such, in a specific embodiment of the present disclosure, the upper shell further comprises a first opening through which the fluid sanitizer can be dispensed. The opening can be sized and shaped to accommodate movement of the nozzle or discharge tube when, for example, a pump control is depressed and released. Preferably, the opening is on the side of the shell, and the nozzle or discharge tube coupled to the pump protrudes through the opening substantially perpendicular to the side.

To initiate delivery of the fluid sanitizer, the upper assembly may further comprise a pump control which is configured to contact the pump of the dispenser when depressed. This control can be contacted by the user directly, such as via a second opening of the upper shell. Alternatively, the control can be contacted via a depressible section, such as a flexible rubber or plastic button, provided on the upper shell that is configured to engage the pump control. For example, the depressible section can be positioned at the top of the fluid dispensing apparatus, which, when depressed by a user, would contact the pump control to actuate pumping action and dispensing of fluid sanitizer. In this way, the pump control is not contacted directly, and the depressible section or button, which can be flush with the outer surface of the upper shell, can prevent foreign substances from entering the upper compartment and interfering with or damaging the pump or nozzle of the fluid dispensing apparatus.

The fluid dispensing apparatus may also comprise a means to prevent delivery of fluid sanitizer by blocking movement of the dispenser, thereby preventing accidental or inadvertent release and spills of the sanitizer. For example, a removable plug may be inserted in the first opening below the nozzle to prevent movement of the nozzle and the dispensing of the fluid sanitizer. The removable plug may have a firm friction fit when inserted into the first opening of the upper shell, and may be made of any suitable materials, such as a soft silicone. Additionally, the removable plug may include a channel that receives a portion of the discharge tube to provide a better fit.

Specific embodiments and components of the portable fluid dispensing apparatus of the present disclosure are shown in the drawings and discussed below. However, it should be apparent to those skilled in the art that these are merely illustrative in nature and not limiting, being presented by way of example only. Numerous modifications and other embodiments are within the scope of ordinary skill in the art and are contemplated as falling within the scope of the present disclosure. In addition, those skilled in the art should appreciate that the specific configurations are illustrative and that actual configurations will depend on the specific system. Those skilled in the art will also be able to recognize and identify equivalents to the specific elements shown, using no more than routine experimentation.

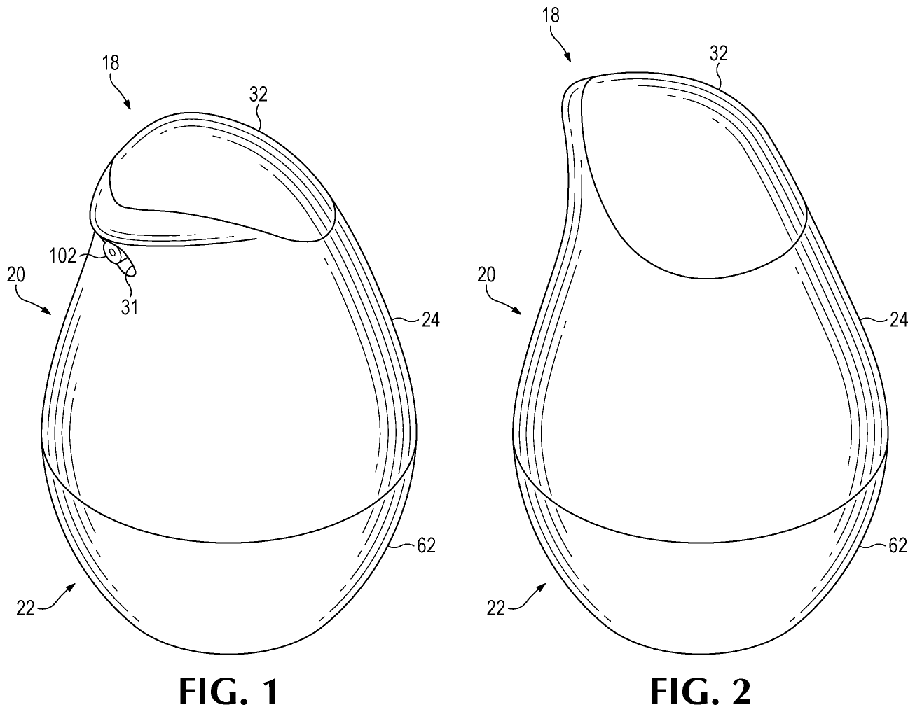

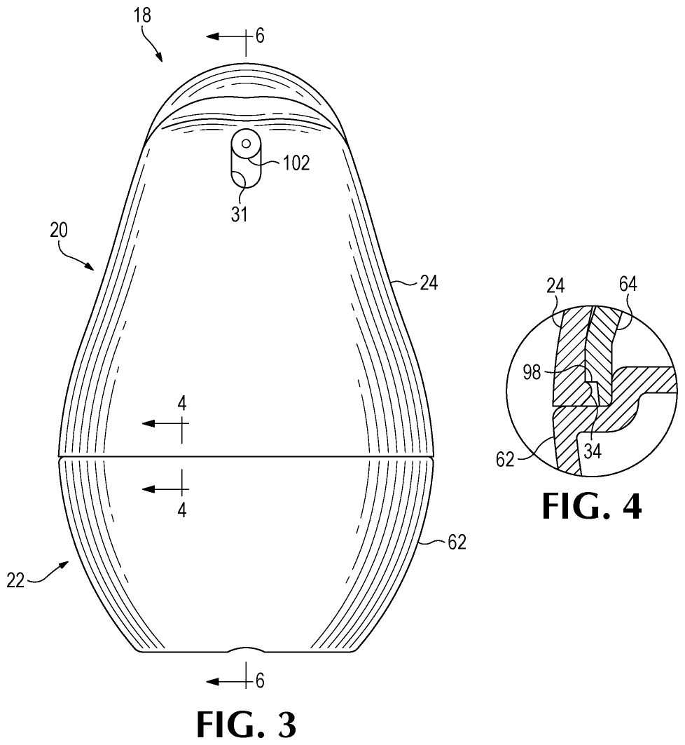

One example of the portable fluid dispensing apparatus of the present disclosure is shown in FIGS. 1-9 and is generally indicated at 18. Unless explicitly excluded, the portable fluid dispensing apparatus of FIGS. 1-9 may additionally, or alternatively, include one or more components of one or more other portable fluid dispensing apparatuses of the present disclosure. As shown, the apparatus comprises an upper assembly 20 and a lower assembly 22.

The upper assembly comprises an upper shell 24, a fluid dispenser 26, and a pump control or pump control member 28. In the example shown in FIGS. 1-9, the upper shell has a generally rounded outer profile, and the ergonomic design allows the device to be comfortably held in a user's hand, particularly when dispensing fluid hand sanitizer. In some embodiments, the upper shell has a curved outer surface 29. The upper shell defines an internal compartment 30. As shown, the upper shell further comprises a discharge opening 31 in the side of the upper shell through which a discharge nozzle (when included) attached to a pump of fluid dispenser 26 may protrude horizontally both when being depressed for sanitizer dispensing and when returning to the undepressed position. Given the general curvature or curvilinear shape of the upper shell, the position and shape of the side opening, and the position of the discharge nozzle, the upper shell, in some embodiments, has the general shape of a bird, particularly when coupled with a generally or substantially spherical base shell.

The upper shell further comprises a depressible portion 32, which is a separable cap or covering configured to engage a pump control positioned over fluid dispenser 26, as further discussed below. For example, the depressible portion may be a section of upper shell 24 and flush with (or conforms to) the contour of the shell, but prepared using a flexible rubbery material such as, for example, a thermoplastic elastomer, as opposed to the more rigid material of the shell, which may be, for example, a polyolefin such a polypropylene. In this way, the fluid dispenser may be depressed or actuated from outside the device, with the contents and components within safe from dirt or damage. The upper shell includes at least one projection or rib 34 on its inside surface 36 to receive at least one recess or channel on an outer surface of a lid of lower assembly 22 to attach or fixedly attach the lid and upper shell together, as best shown in FIG. 4. Alternatively, the upper shell may include the at least one recess or channel and the outer surface of the lid ma include the at least one projection. The upper shell and/or the lid may additionally, or alternatively, include other forms of coupling structures, such as ribs, apertures, etc.

Fluid dispenser 26 is received in internal compartment 30. In the example shown in FIGS. 1-9, the fluid dispenser includes an actuator nozzle 42, a supply tube 44, and a pump 46 disposed between and fluidly connected to the actuator nozzle and the supply tube. Supply tube 44 is received in the internal compartment of lower assembly 22 to access the stored fluid sanitizer. Actuator nozzle 42 activates pump 46, such as by downward movement of the actuator nozzle relative to the pump, to dispense fluid stored in the lower assembly. The pump can be any suitable pump capable of dispensing a fluid hand sanitizer, such as in a spray form or in fluid shots. Examples of a pump attached to a pump control are shown in U.S. Pat. No. 9,913,561, the complete disclosure of which is hereby incorporated by reference for all purposes. In the example shown in FIGS. 1-9, pump 46 includes a spring cup 48 attached to actuator nozzle 42 and a spring 50 that urges the spring cup and the actuator nozzle away from lower assembly 22. Fluid dispenser 26 is attached to a neck portion of the lid of lower assembly 22, such as via a valve cup 51.

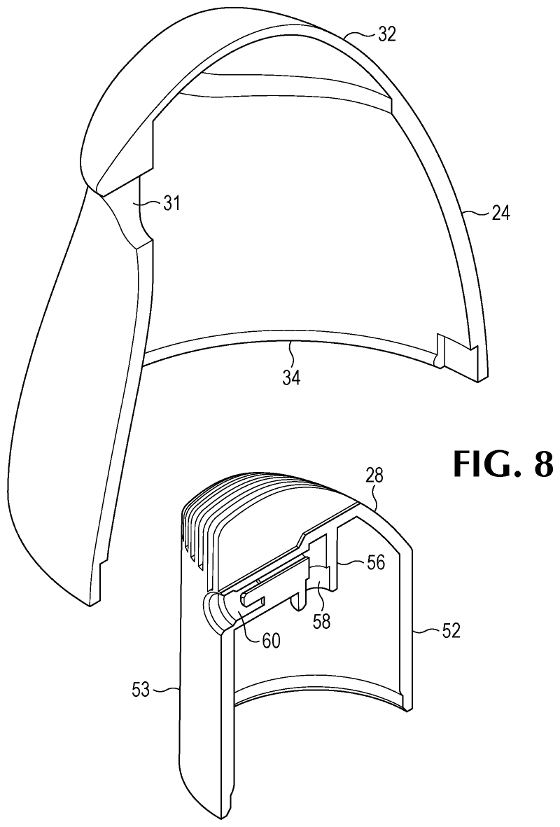

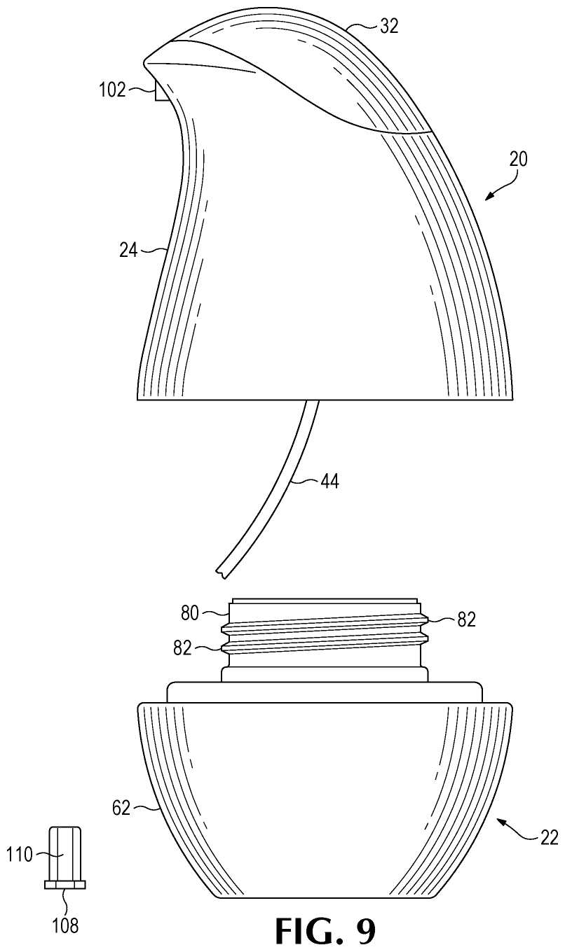

Pump control 28 is attached to (or positioned over the top of) the pump and is adjacent to and/or in contact with the depressible portion of the upper shell for the user to activate the pump and dispense fluid sanitizer. The pump control includes a control shell 52 having at least one control wall 53 defining an internal cavity 54, as best shown in FIG. 8. Pump control 28 also includes a control tube 56, which may be substantially or full received in internal cavity 54. The control tube includes an intake end portion 58 and a discharge end portion 60. Intake end portion 58 is connected to actuator nozzle 42 of fluid dispenser 26 such that actuator nozzle 42 is actuated and/or moved downward when pump control 28 is moved downward by a user. In the example shown in FIGS. 1-9, an end portion of actuator nozzle 42 is received in intake end portion 58. Discharge end portion 60 is positioned along the outside perimeter of control shell 52 such that fluid sanitizer received in the intake end portion can be discharged external or out of control shell 52 and through discharge opening 31. In the example shown in FIGS. 1-9, control tube 56 is incorporated or formed with control shell 52. However, in other embodiments, control tube 56 may be attached to the control shell.

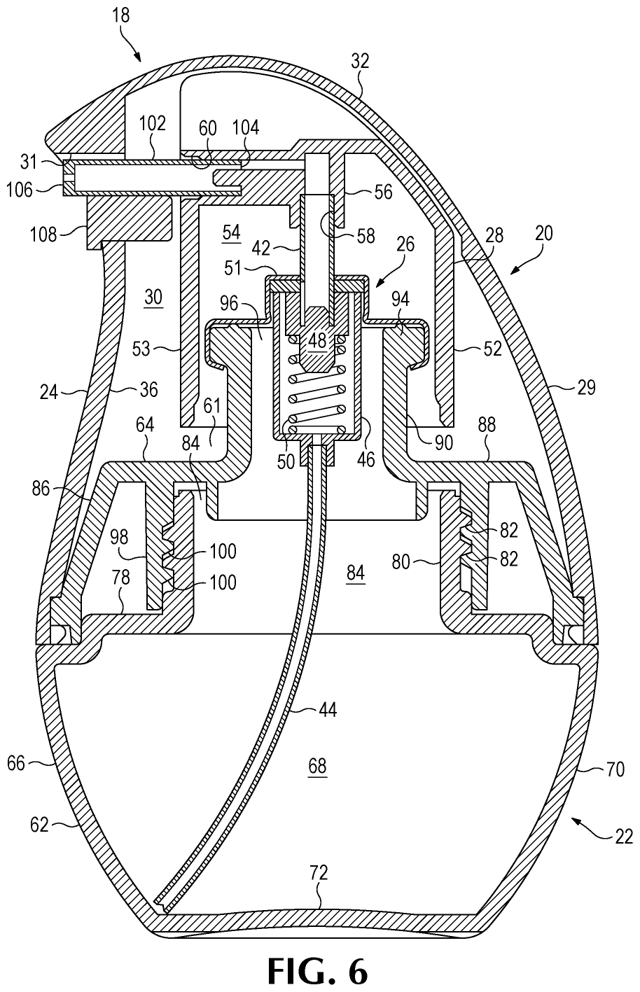

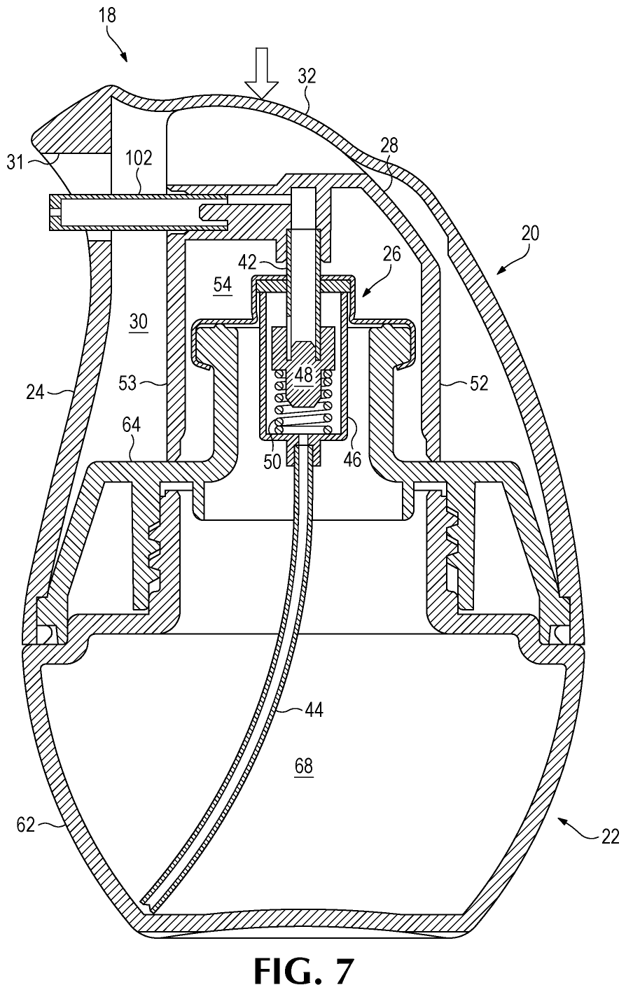

The control wall(s) of control shell 52 is sized to allow movement of pump control 28 relative to the lower assembly. Control wall 53 has a height that provides a gap 61 between control shell 52 and a lid of lower assembly 22 to allow movement of pump control 28 from a nominal or unactuated position shown in FIG. 6 to an actuated or discharge position shown in FIG. 7 when a user pushes pump control 28 downward and/or toward lower assembly 22. Discharge opening 31 is sized and shaped to maintain fluid communication with discharge end portion 60 in both the actuated and unactuated positions. In the example shown in FIGS. 1-9, discharge opening 31 is stadium-shaped. However, discharge opening 31 may include other shapes, such as ovals, elongated circles, etc. As best shown in FIGS. 6-7, fluid dispenser 26 and pump control 28 is at least substantially or fully received in internal compartment 30 of upper shell 24.

Lower assembly 22 includes a base shell 62 and a lid 64. Base shell 62 includes one or more walls 66 that define an internal fluid compartment 68. As best shown in FIGS. 6-7, walls 66 includes at least one side wall 70, at least one floor wall 72, at least one ceiling wall 78, and at least one coupling wall 80 formed together to define internal fluid compartment 68. Coupling wall(s) 80 include a plurality of threads 82 that correspond to the threads on lid 64 further discussed below. Coupling wall(s) 80 define a compartment opening 84 therebetween to provide access to the fluid sanitizer stored in internal fluid compartment 68. The coupling walls also may be referred to as forming a neck portion having compartment opening 84. In the example shown in FIGS. 1-9, base shell 62 is substantially spherical in shape and thus only a single side wall 70, a single floor wall 72, a single ceiling wall 78, and a single coupling wall 80 are formed together to define the internal fluid compartment. However, other embodiments of base shell 62 may include other suitable shapes that may include two or more side walls, floor walls, ceiling walls, etc. Additionally, in the example shown in FIGS. 1-9, walls 66 define both the exterior or outer surface of the base shell and the interior surface that contains the fluid sanitizer. In other words, there are no walls or other structures that define an internal compartment separate from the walls that define the external walls or external perimeter of the base shell.

Lid 64 includes a lid shell 84 having at least one side wall 86, at least one ceiling wall 88, and at least one flange wall 90 formed together to define an internal lid compartment 92. The flange wall(s) are spaced to define a lid neck portion 94 having a dispenser opening 96. The fluid dispenser is attached to the lid neck portion as previously discussed. Discharge opening 96 is in fluid communication with compartment opening 84 and internal fluid compartment 68. Side wall(s) 86 include at least one recess or channel 98 to receive rib(s) or projection(s) 34 of upper shell 24 to attach or fixedly attach the lid and the upper shell, as best shown in FIG. 4. Additionally, at least one internal wall 98 extends downward from the ceiling wall(s) and include a plurality of threads 100 that correspond to the threads of base shell 62. Although a threaded connection is shown between the base shell and the lid, those components may be removably coupled in other suitable ways, such as snapped together or via clips or mated inserts. The removable connection between the base shell and the lid allows a user to selectively remove or detach the base shell from the rest of the device (as the lid is coupled to the upper shell as discussed above) to re-fill the base shell with fluid sanitizer, as shown in FIG. 9. Additionally, in the example shown in FIGS. 1-9, lid shell 84 is shaped to be generally frustoconical with lid neck portion 94. However, other embodiments of lid shell 84 may include other suitable shapes.

The upper and lower assembly may be made with any suitable material(s). For example, the base shell and the lid may be made of suitable materials capable of withstanding contact with the fluid sanitizer without degrading or becoming damaged, especially alcohol based hand sanitizer. Examples include polyolefins, such a polyethylene, and polyesters, such as PET.

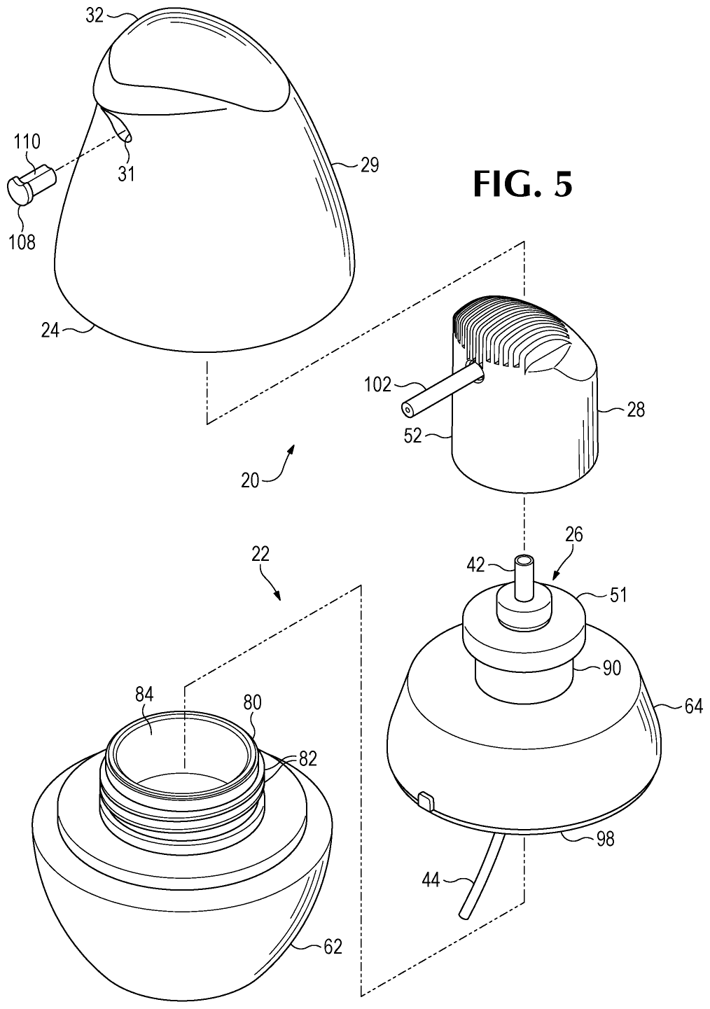

In the example shown in FIGS. 1-9, upper assembly 20 also includes a discharge tube 102 having opposed end portions 104 and 106. The discharge tube is received in discharge opening 31 and internal compartment 30 of the upper shell. End portion 104 is connected or fluidly connected to and/or received in discharge end portion 60 of control tube 56 and end portion 106 extends outward of discharge opening 31 of upper shell 24. As previously discussed, and best shown in FIGS. 6-7, discharge opening 31 is sized and shaped to allow downward movement of discharge tube 102 when pump control 28 is moved downward toward the lower assembly to actuate the fluid dispenser and dispense the fluid sanitizer from the interior fluid compartment. The spring of the fluid dispenser returns the pump control to the position shown in FIG. 5.

In the example shown in FIGS. 1-9, portable fluid dispensing apparatus 18 includes a removable plug 108 that is insertable in discharge opening 31 of the upper shell just below discharge tube 102 to prevent downward movement of the discharge tube, which prevents dispensing of the fluid sanitizer, as best shown in FIG. 6. The plug includes a channel 110 to allow positioning of the plug just below the discharge tube. The removable plug may have a firm friction fit when inserted into the discharge opening of the upper shell, and may be made of any suitable materials, such as a soft silicone. The plug is removed prior to use of the device and may be re-inserted if desired to prevent accidental dispensing of the fluid sanitizer.

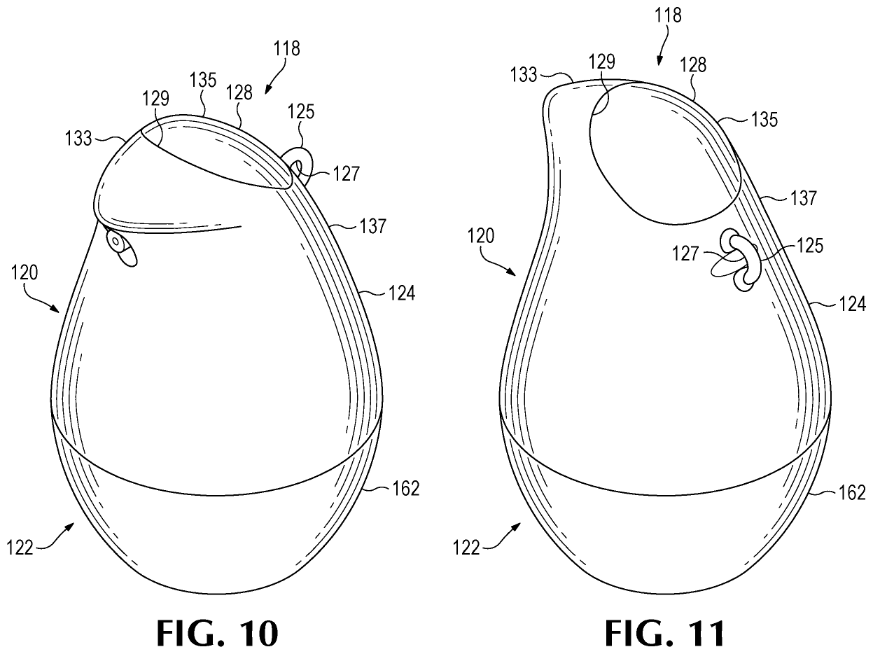

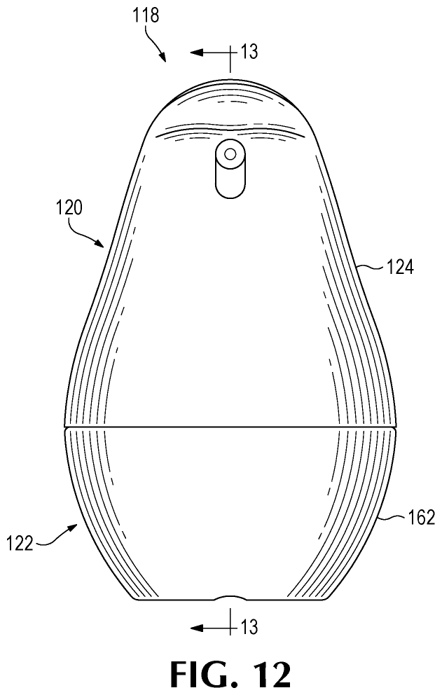

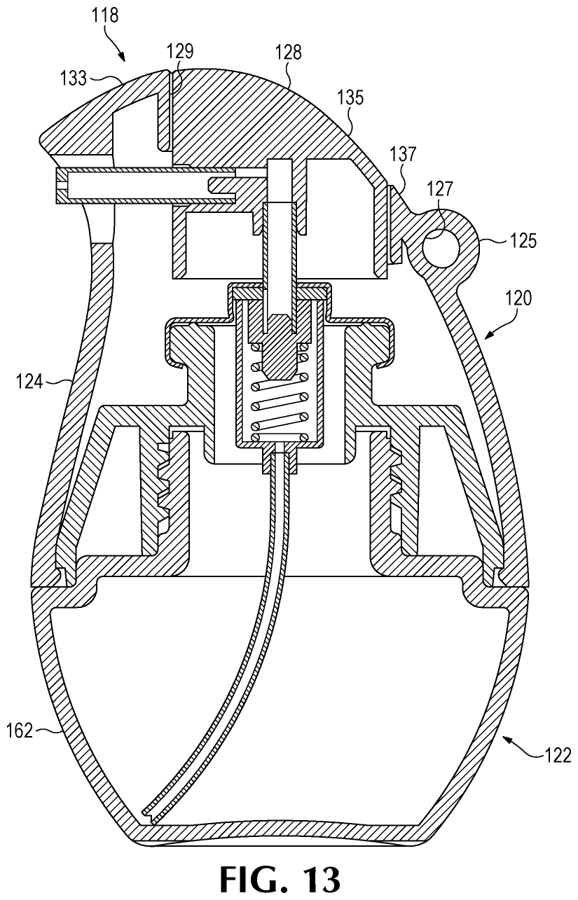

Another example of portable fluid dispensing apparatus 18 is shown in FIGS. 10-13 and generally indicated at 118. Unless explicitly excluded, the portable fluid dispensing apparatus of FIGS. 10-13 may additionally, or alternatively, include one or more components of one or more other portable fluid dispensing apparatuses of the present disclosure. Portable fluid dispensing apparatus 118 is substantially similar to portable fluid dispensing apparatus 18. For example, portably fluid dispensing apparatus 118 comprises an upper assembly 120 having an upper shell 124 and a lower assembly 122. However, unlike the portable fluid dispensing apparatus 18, portable fluid dispensing apparatus 118, upper shell 124 includes a half loop 125 formed on the outer surface of the upper shell. The half loop defines an aperture 127, which may be used to receive a carabineer, keychain, and/or other suitable structures.

Additionally, upper shell 124 includes an access opening 129, such as on a top portion 133 of the upper shell, which allows a user access to a pump control 128 from external upper shell 124. In the example shown in FIGS. 10-13, an outer top surface 135 of pump control 128 is flush with (or conforms or corresponds with) an outer surface 137 of upper shell 124. In other words, the outer top surface of pump control 128 is shaped to correspond with the shape of the upper shell just adjacent to the access opening and the pump control is sized to substantially fill access opening 129 such that access opening 129 appears to be part of the upper shell with small gaps to allow movement of the pump control downward (or toward lower assembly 22) to actuate the fluid dispenser and dispense the fluid sanitizer stored in an interior fluid compartment 168 of a base shell 162 of lower assembly 122.

Thus, the present disclosure also relates to a method of dispensing fluid sanitizer and dry wipes from a single portable device. For example, the method may comprise providing a portable fluid dispensing apparatus as described above, having an upper shell and base shell, filling a lower compartment with fluid sanitizer and attaching the lower compartment to the rest of the device. The method further comprises removing a removable plug from the side opening of the upper shell. Once removed, the method further comprises dispensing fluid sanitizer by depressing the pump control to contact the pump inserted into the fluid sanitizer. Other variations of use of the portable fluid dispensing apparatus described above are included in the present disclosure.

The foregoing description of preferred embodiments of the present disclosure has been presented for the purposes of illustration and description. It is not intended to be exhaustive or to limit the disclosure to the precise form disclosed. Modifications and variations are possible in light of the above teachings, or may be acquired from practice of the disclosure. The embodiments were chosen and described in order to explain the underlying principles and their practical application to enable one skilled in the art to utilize the disclosure in various embodiments and with various modifications as are suited to the particular use contemplated. It is intended that the scope of the disclosure be defined by the claims appended hereto and their equivalents.

The specific embodiments disclosed and illustrated herein are not to be considered in a limiting sense as numerous variations are possible. The subject matter of the present disclosure includes all novel and non-obvious combinations and subcombinations of the various elements, features, functions and/or properties of the embodiments disclosed herein. Similarly, where the claims recite “a” or “a first” element or the equivalent thereof, such claims should be understood to include incorporation of one or more such elements, neither requiring nor excluding two or more such elements.

Various combinations and subcombinations of features, functions, elements, and/or properties may be claimed through presentation of new claims in a related application. Such new claims, whether they are directed to a different invention or directed to the same invention, whether different, broader, narrower or equal in scope to the original claims, are also regarded as included within the subject matter of the present disclosure.

What is claimed is:

1. A portable fluid dispensing apparatus comprising an upper assembly and a lower assembly,
wherein the lower assembly includes:
a base shell defining a first internal compartment and a first opening providing access to the first internal compartment; and
a lid removably coupled to the base shell, the lid having a neck portion that includes a second opening, the second opening being in fluid communication with the first opening and with the first internal compartment, and
wherein the upper assembly includes:
an upper shell defining a second internal compartment, the upper shell being attached to the lid and having a first aperture;
a fluid dispenser attached to the neck portion of the lid and received in the second internal compartment, the fluid dispenser including an actuator nozzle, a first tube received in the first internal compartment of the base shell, a pump disposed between the nozzle and the first tube; and
a pump control member having a control shell defining an internal cavity and a second tube with first and second end portions, the first end portion being connected to the actuator nozzle and the second end portion being in fluid communication with the first aperture of the upper shell, the pump control member being sized to allow movement of the pump control member and the actuator nozzle toward the pump to activate the pump and dispense fluid stored in the first internal compartment.

2. The apparatus of claim 1, wherein an outer surface of the upper shell includes a depressible portion adjacent to the pump control member such that the pump control member and the actuator nozzle are moved toward the pump by pressing on the depressible portion.

3. The apparatus of claim 2, wherein the outer surface with the depressible portion is on a top portion of the upper shell.

4. The apparatus of claim 2, wherein the outer surface of the upper shell is curvilinear.

5. The apparatus of claim 1, wherein the upper shell includes a second aperture, and wherein the control shell is sized to be received in the second aperture and includes an outer surface that is flush with the outer surface of the upper shell.

6. The apparatus of claim 1, wherein the upper assembly further includes a third tube received in the first aperture of the upper shell, the third tube having opposed third and fourth end portions, the third end portion being fluidly connected to the second end portion of the second tube, and the fourth end portion extending outward of the first aperture of the upper shell.

7. The apparatus of claim 6, wherein the first aperture of the upper shell is sized to allow movement of the third tube within the first aperture when the pump control member and the actuator nozzle are moved toward the pump.

8. The apparatus of claim 7, further comprising a removable plug sized to be received in the first aperture to prevent movement of the third tube within the first aperture.

9. The apparatus of claim 1, wherein the base shell includes threads and the lid includes corresponding threads.

10. The apparatus of claim 1, wherein the base shell includes a neck portion having threads, and the lid includes at least one internal wall having corresponding threads.

11. The apparatus of claim 1, wherein the second tube is formed with the control shell.

12. The apparatus of claim 1, wherein the upper shell has a rounded outer profile that conforms to a user's hand when the pump control member is moved toward the base shell.

13. The apparatus of claim 1, wherein the base shell has a substantially spherical shape that conforms to a user's hand when held.

14. The apparatus of claim 13, wherein the base shell has a flat bottom portion that enables the apparatus to stand upright.

15. The apparatus of claim 1, wherein the upper shell includes a half loop defining a third aperture, the half loop being formed on the outer surface of the upper shell.
